(19) United States
(12) Patent Application Publication
(10) Pub. No.: US 2001/0052858 A1
(43) Pub. Date: Dec. 20, 2001

(54) Access system to an item of automatic control equipment via a wireless proximity network

(75) Inventors: Christophe Vincent, La Roquette-Sur-Siagne (FR); Christian Hardy, Le thoronet (FR); Jean-Marie Stawikowski, Antibes (FR); Robert Rousseau, Antibes (FR)

Correspondence Address: PARKHURST & WENDEL, L.L.P., Suite 210, 1421 Prince Street, Alexandria, VA, 22314-2805, US

(73) Assignee: SCHNEIDER AUTOMATION

(21) Appl. No.: 09/880,779

(22) Filed: Jun. 15, 2001

(30) Foreign Application Priority Data
Jun. 16, 2000 (FR) 00 07760

(51) Int. Cl. G08C 19/00

(52) U.S. Cl. 340/825.69

(57) ABSTRACT

The present invention relates to an access system between an item of server automatic control equipment (20), which integrates transmission/reception means (25) to transmit and receive messages on a wireless proximity network (30) using a radio wave technology in compliance with the Bluetooth protocol, and at least one mobile device (10) or at least one item of client automatic control equipment (20′). An item of server automatic control equipment (20) comprises server communication means (27) to implement a link mechanism in order to supply control, display and monitoring functions of the server automatic control equipment from a mobile device or an item of client automatic control equipment.

The present invention relates to an access system to an item of automatic control equipment via a wireless proximity network, using the Bluetooth protocol for example, from at least one mobile device or from another item of automatic control equipment. This system may be applied to any application belonging to the field of industrial automatic control systems, building automatic control systems and electrical distribution network monitoring and control.

A local connection between an item of automatic control equipment and a mobile device makes it possible, particularly for maintenance or operating operators equipped with such a mobile device, to occasionally access, by means of a man/machine interface integrated in the mobile device, control, display and monitoring functions, when said operators are located in proximity to the automatic control equipment to be monitored, i.e. at a distance typically of the order of a few meters. The term “automatic control equipment” hereafter refers to a PLC, an input/output module, a regulation device, an monitoring and control station, a man-machine dialogue terminal, a intelligent sensor/actuator or any other equipment related at an automatic control application. The term “mobile device” hereafter refers to a mobile telephone, a laptop computer, a PDA (Personal Digital Assistant), but also any automatic control equipment peripheral liable to be moved, such as a printer.

Such a local connection usually requires an electrical connection via a cable to a connection point either point to point or via a LAN. However, it is not always easy to carry out a reliable wire connection if the automatic control equipment is difficult for the operator to access, either due to an inaccessible geographic location or for access safety reasons (tightness, harmful atmosphere). In addition, in the long-term, repeated connections and disconnections of mobile devices may damage connection points.

Another requirement consists of wishing to make a local connection between several items of automatic control equipment, for example, if one or more items of automatic control equipment are embedded on a mobile support, such as a truck, travelling crane, etc. According to the location of the mobile support, it is required to have said mobile item of automatic control equipment communicate occasionally with another item of automatic control equipment located in proximity for example for control and monitoring functions (transmission of orders and instructions, reception of reports, etc.).

Wireless connections produced using infrared technology already exist. However, these connections are directional and may be interrupted as soon as an obstacle is located between the transmitter and the receiver, which reduces their interest in certain automatic control applications. A rapid, reliable and easy-to-implement proximity connection would therefore be considered as significant progress for operating and maintenance operations on automatic control equipment. For this reason, a radio wave technology would enable improved connection reliability.

In addition, to enable the communication of automatic control equipment and mobile devices of very diverse origins, it would be desirable to have a standard technology enabling a large number of different devices to detect and identify each other automatically for a user. The Bluetooth protocol is a radio wave high-speed wireless proximity technology. This technology, derived from the world of telecommunications and information technology, comes from the “Bluetooth SIG” (Special Interest Group) and enables communication between several devices located at a distance of the order of ten meters from each other (excluding repeaters and according to the state of the art). It does not require configuration since any device within the field covered by a proximity network is automatically detected and synchronised with the other devices connected to this proximity network in order to be able to communicate.

Therefore, it would be of interest to use this technology in the field of automatic control systems to provide a solution for the above-mentioned problems, i.e. provide a rapid connection from a mobile device particularly for operating and maintenance operations on automatic control equipment or provide a rapid connection between several items of automatic control equipment for control and monitoring functions.

In this way, using the invention, an operating or maintenance operator, managing for example several autonomous items of automatic control equipment located at different locations, could rapidly access each item of automatic control equipment from a mobile device without needing an electrical connection and without a specific procedure, thus facilitating said operator's work.

Similarly, items of automatic control equipment, particularly automatic control equipment embedded in installations liable to be moved, could easily communicate with each other (occasionally or not according to their relative location), using an access system according to the invention, enabling them to detect and identify each other transparently with respect to automatic control application programs, so as to be able to exchange messages and information.

For this reason, the invention relates to an access system between an item of server automatic control equipment, which integrates transmission/reception means to transmit and receive messages on a wireless proximity network using a radio wave technology and at least one mobile device or at least one item of client automatic control equipment. This access system is characterised in that the server automatic control equipment comprises server communication means capable of implementing a link mechanism in compliance with the Bluetooth protocol with communication means of a mobile device or with client communication means of an item of client automatic control equipment, in order to supply control, display and monitoring functions from the server automatic control equipment, wherein the link mechanism comprises a detection phase, a description phase and a service phase.

The client communication means or the server communication means of an item of automatic control equipment have access to an internal memory containing information relating to the automatic control equipment. According to a characteristic of the invention, the same item of automatic control equipment may comprise both server communication means and client communication means.

The invention also relates to an item of automatic control equipment characterised in that it communicates on a proximity network by means of an access system according to any of the above claims.

Other characteristics will be seen in the following detailed description referring to an embodiment given as an example and represented in the appended figures wherein:

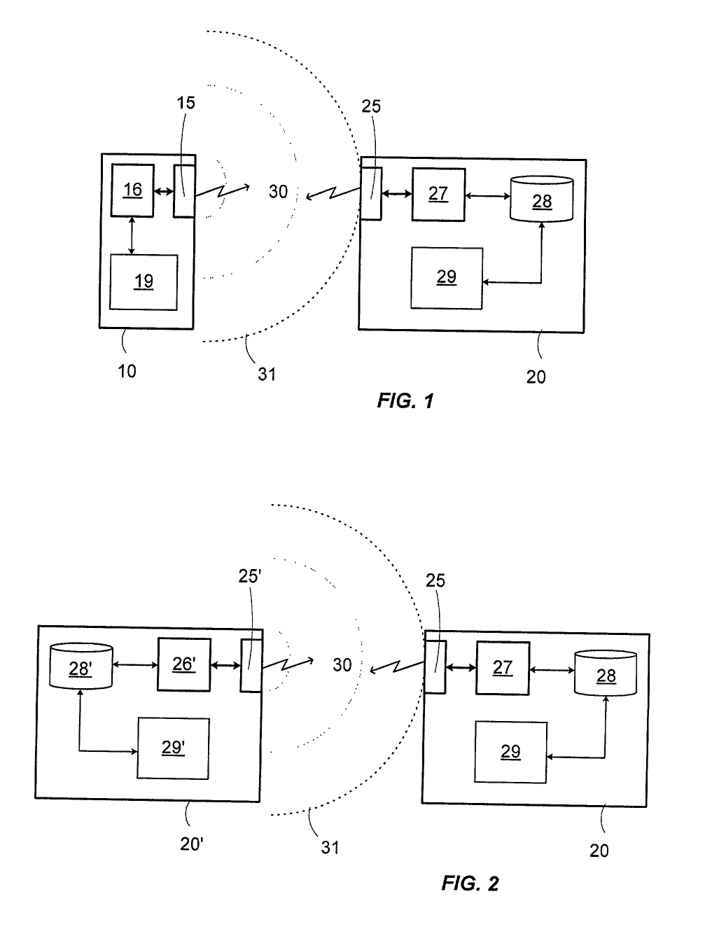

FIG. 1 represents an example of architecture of the access system described in the invention between a mobile device and an item of server automatic control equipment,

FIG. 2 represents another example of architecture of the access system described in the invention between an item of client automatic control equipment and an item of server automatic control equipment,

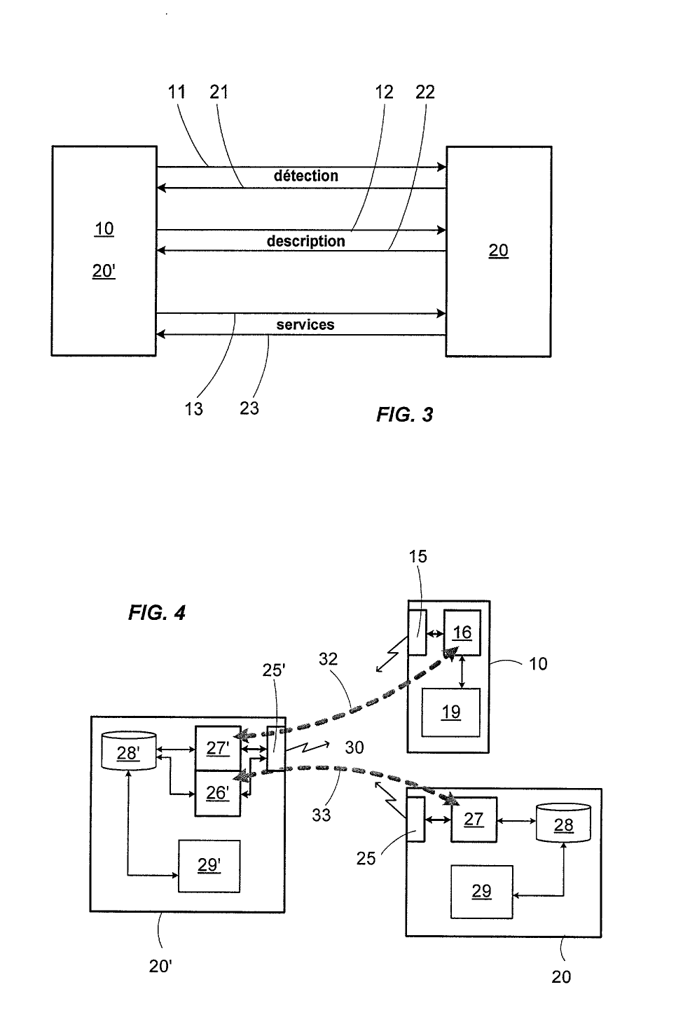

FIG. 3 is a schematic representation of the different possible types of messages,

FIG. 4 represents an item of automatic control equipment which is both client and server.

In FIG. 1, an item of server automatic control equipment 20 comprises transmission/reception means 25, connected to server communication means 27, themselves able to access an internal memory 28 of data from the server automatic control equipment 20. This internal memory 28 which particularly contains information relating to the status of the server automatic control equipment 20 and the representative variables of an automatic control application controlled by the automatic control equipment. It is also accessible to an automatic control application program 29 which can run in the server automatic control equipment 20 to control and monitor an automatic control application. It is thus possible to exchange information between the application program 29 and the server communication means 27. The transmission/reception means 25 are in charge of transmitting and receiving messages on a wireless proximity network 30, using a radio wave technology supporting the Bluetooth protocol. Therefore, the transmission/reception means 25 integrate the components required for the operation of the Bluetooth protocol particularly a Bluetooth chipset.

The server communication means 27 are capable of implementing a link mechanism with communication means 16 of at least one mobile device 10. Said mobile device 10 comprises transmission/reception means 15 to transmit and receive messages on the proximity network 30, connected to the communication means 16. The mobile device 10 also comprises a man-machine interface 19, which includes for example a keyboard or a screen, using which a user of the mobile device 10 can send queries and display responses.

FIG. 2 shows an item of server automatic control equipment 20 linked by a proximity network 30 to an item of client automatic control equipment 20′, comprising transmission/reception means 25′ in charge of transmitting and receiving messages on a wireless proximity network 30, using a radio wave technology supporting the Bluetooth protocol. Said transmission/reception means 25′ are connected to client communication means 26′, themselves able to access an internal data memory 28′. Said internal memory 28′ which particularly contains information relating to the status of the server automatic control equipment 20′ and the representative variables of an automatic control application controlled by the automatic control equipment. It is also accessible to an automatic control application program 29′ which can run in the server automatic control equipment 20′ to control and monitor an automatic control application. It is thus possible to exchange information between the application program 29′ and the client communication means 26′. In addition, the server communication means 27 are capable of implementing a link mechanism with the client communication means 26′ of at least one item of client automatic control equipment 20′.

An item of automatic control equipment has a server function when it is able to receive and respond to a query sent by a client (in this case, this equipment may be referred to as a server). Conversely, an item of automatic control equipment has a client function when it is able to send a query to a server and receive the response from the server (in this case, this equipment may be referred to as a client).

To set up a link mechanism, a client (i.e. a mobile device 10 and an item of client automatic control equipment 20′) firstly enters the detection phase to try to detect the presence of at least one server (i.e. an item of server automatic control equipment 20) in the field of action 31 of the proximity network 30. For this, with reference to FIG. 3, the communication means of a client 16, 26′ generate a detection query 11. In the case of client automatic control equipment 20′, this detection query 11 is generated by the communication means 26′ at regular intervals, at the operator's request, or following an order from the application program 29′.

The server communication means 27 are continuously capable of receiving a detection query 11. Upon reception of such a query, they generate a detection response 21 used to signal to the sender of the query 11 the presence of an item of server automatic control equipment 20 in the field of action 31 of the proximity network 30.

Upon reception of said detection response 21, the client 10, 20′ continues to set up the link mechanism by initiating the description phase wherein the communication means of a client 16, 26′ generate a description query 12 intended for the server automatic control equipment 20 that responded to the detection query 11. When it receives said description query 12, it returns a description response 22 which may include an identification and authentication of the server automatic control equipment 20, and a list of the services offered which will be accessible to the client(s).

According to the type of server automatic control equipment 20, the services offered to the user of a mobile device 10 or to the application program 29′ of an item of client automatic control equipment 20′ particularly comprising application program loading and unloading, reading and writing of internal variables and inputs/outputs, monitoring statuses and faults, controlling part or all of the automatic control equipment, etc., thus providing control, display and monitoring functions of the server automatic control equipment 20. All these services may clearly comprise a secure access using passwords, identification keys, or other suitable means.

When the detection response 22 from the server automatic control equipment 20 is received by the client 10, 20′, the link mechanism is set up and the service phase is started. At the request of a user of a mobile device 10 and according to the services offered, the communication means 16 may generate service queries 13 to the server automatic control equipment 20 and wait for the corresponding service responses 23. Similarly, at the request of the application program 29′ of an item of client automatic control equipment 20′ and according to the services offered, the client communication means 26′ may also generate service queries 13 to the server automatic control equipment 20 and wait for the corresponding service responses 23.

An item of automatic control equipment such as that described in the invention can simultaneously have a server function and a client function. For this, it must comprise server communication means 27′ and client communication means 26′, able to access the internal memory 28′, as shown in FIG. 4. In this example, an item of automatic control equipment 20′ has a server function 32 in relation to a mobile device 10, while also having a client function 33 in relation to another item of server automatic control equipment 20.

Other examples of use of the present invention can be envisaged. For example, the front panel of automatic control equipment frequently comprises signalling means such as LEDs or digital displays. However, when automatic control equipment cannot be installed in the visual field of an operator located in proximity, their signalling means lose their purpose. In addition, installing display means on all automatic control equipment is a costly solution, since they are only useful in the presence of an operator. Using the present invention, it is therefore possible to envisage a portable display device serving as a mobile client device and enabling an operator equipped with such a device to replace signalling means when in proximity to an item of server automatic control equipment.

More generally, the invention may also be used to centralise various peripherals, such as a keyboard, a printer, etc., for occasional shared use between several items of remote server automatic control equipment. When operators wish to use a particular peripheral in connection with a given item of server automatic control equipment, they simply position said peripheral in proximity to the server automatic control equipment for the required operating time, which avoids electrical connections and makes it possible to optimise the number of peripherals in this way.

Naturally, without leaving the scope of the invention, it is possible to envisage other variants and perfection of details and even the use of equivalent means.

1. Access system between an item of server automatic control equipment (20), which integrates transmission/reception means (25) to transmit and receive messages (11, 12, 13, 21, 22, 23) on a wireless proximity network (30) using a radio wave technology, and at least one mobile device (10) or at least one item of client automatic control equipment (20′), characterised in that the server automatic control equipment (20) comprises server communication means (27) capable of implementing a link mechanism in compliance with the Bluetooth protocol with communication means (16) of a mobile device (10) or with client communication means (26′) of an item of client automatic control equipment (20′), in order to supply control, display and monitoring functions from the server automatic control equipment (20), the link mechanism comprising a detection phase, a description phase and a service phase.

2. Access system according to claim 1, characterised in that the client communication means (26′) or the server communication means (27, 27′) of an item of automatic control equipment (20) have access to an internal memory (28) containing information relating to the automatic control equipment (20).

3. Access system according to claim 2, characterised in that the same item of automatic control equipment (20′) may comprise server communication means (27′) and client communication means (26′), to be able to perform a server function and a client function.

4. Access system according to claim 2 or 3, characterised in that the server communication means (27) of an item of server automatic control equipment (20) are waiting for a detection query (11) sent by at least one mobile device (10) or at least one item of client automatic control equipment (20′) on the proximity network (30).

5. Access system according to claim 4, characterised in that, following the reception of a detection query (11) from a mobile device (10) or an item of client automatic control equipment (20′), the server communication means (27) generate a detection response (21) used to signal their presence to the mobile device (10) or the client automatic control equipment (20).

6. Access system according to claim 2 or 3, characterised in that the client communication means (26′) of an item of client automatic control equipment (20′) transmit detection queries (11) on the proximity network (30), in order to detect the presence of at least one item of server automatic control equipment (20) in the field of action (31) of the proximity network (30).

7. Access system according to claim 6, characterised in that the detection queries (11) are transmitted by the client communication means (26′) at regular intervals or at the initiative of an application program (29′) running in the client automatic control equipment (20′).

8. Access system according to any of claim 5 or 6, characterised in that the server communication means (27) respond to a description query (12) transmitted by a mobile device (10) or by an item of client automatic control equipment (20′) by returning a description response (22) which can include an identification and authentication of the automatic control equipment (20) and a list of the services offered by the automatic control equipment (20).

9. Access system according to claim 8, characterised in that, when the link mechanism is set up, the server automatic control equipment (20) can exchange messages (13, 23) with a mobile device (10) via the proximity network (30), such that a user of the mobile device (10) can perform control, display and monitoring functions of the server automatic control equipment (20).

10. Access system according to claim 8, characterised in that, when the link mechanism is set up, the server automatic control equipment (20) can exchange messages (13, 23) with an item of client automatic control equipment (20′) via the proximity network (30), such that an application program (29′) running in the client automatic control equipment (20′) can perform control, display and monitoring functions of the server automatic control equipment (20).

11. Automatic control equipment characterised in that it communicates on a proximity network (30) by means of an access system according to any of the above claims.
